(19) United States
(12) Patent Application Publication
(10) Pub. No.: US 2009/0260055 A1
(43) Pub. Date: Oct. 15, 2009

(54) REAL-TIME DATA SHARING AMONG A PLURALITY OF USERS

(75) Inventor: Amar P. Parmar, Santa Rosa, CA (US)

Correspondence Address: IP LEGAL SERVICES, LLC, 1500 E. LANCASTER AVENUE, SUITE 200, P.O. BOX 1027, PAOLI, PA, 19301, US

(73) Assignee: myLinkx Corporation

(21) Appl. No.: 12/422,267

(22) Filed: Apr. 11, 2009

Related U.S. Application Data
(60) Provisional application No. 61/044,449, filed on Apr. 11, 2008.

(51) Int. Cl. H04L 29/06; G06F 17/40

(52) U.S. Cl. 726/1; 726/4

(57) ABSTRACT

Described embodiments provide for accessing stored data representing real-time tracking information shared among a plurality of users. First, a user request for access to stored data is identified. A device type associated with the user request is determined, and one or more permissions for the user request are also determined. Based on the one or more permissions determined, a portion of the stored data is provided to the user through one of a plurality of specialized data views. The selected one of the plurality of specialized data views is selected based on the device type.

### CROSS-REFERENCE TO RELATED APPLICATIONS

This application claims the benefit of the filing date of U.S. provisional patent application No. 61/044,449, filed Apr. 11, 2008, which is expressly incorporated by reference herein in its entirety.

### BACKGROUND OF THE INVENTION

1. Field of the Invention

The present invention relates to sharing data among a plurality of users and, in particular, to maintaining user time and expense tracking data in real-time.

2. Description of the Related Art

Time and expense tracking and reporting is important to individuals and organizations that determine, for example, client billing amounts based on the amount of time spent on a particular project. In general, time tracking requires workers to record start and stop times of periods of work activity, select the client or project for which the activity is performed, compute or record elapsed time during each period of activity or a total elapsed time for multiple periods of activity, and apply a billing rate to the total elapsed time. Further, expenses might be tracked based on the selected client, project or expense category.

Time tracking hardware devices have generally been implemented as physical time clock machines such as punch card systems or identification card scanners, or as biometric hardware based systems such as fingerprint scanners. Time tracking software applications have generally been implemented as computer-based timeclocks, typically requiring static entries and submittals of worker information. For example, a worker might enter a start and stop time into a form to be submitted to their supervisor. Alternatively, a worker might start a software timer that tracks their work time on their local computer before submittal to a supervisor. Time tracking software applications for use with mobile devices might require the mobile device clock to be synchronized with a server clock.

For organizations where employees are not present in one physical location, time tracking hardware devices are of little benefit. However, time tracking software applications generally store information locally on each user's computer until it is i) finalized and submitted or ii) exported to a manager or supervisor. Thus, a problem on the user's local computer might cause time tracking data to be lost. Moreover, this time or expense tracking software does not provide for real-time sharing and monitoring of user data. Generally, the user-entered data is not available to others within the organization until the data is submitted. Thus, user-entered data in time tracking software applications might not be verifiable by a supervisor or manager. Other solutions require custom software applications to properly interface with mobile devices. For example, a custom software application might be required to support each different type of mobile device, for example, interfacing with mobile devices such as a Blackberry® might require a separate custom software application than another mobile device, such as an iPhone®. Moreover, less sophisticated mobile devices might not be supported.

### SUMMARY OF THE INVENTION

In an exemplary embodiment, the present invention provides for accessing stored data representing real-time tracking information shared among a plurality of users. First, a user request for access to stored data is identified. A device type associated with the user request is determined, and one or more permissions for the user request are also determined. Based on the one or more permissions determined, a portion of the stored data is provided to the user through one of a plurality of specialized data views. The selected one of the plurality of specialized data views is selected based on the device type.

### BRIEF DESCRIPTION OF THE DRAWINGS

Other aspects, features, and advantages of the present invention will become more fully apparent from the following detailed description, the appended claims, and the accompanying drawings in which like reference numerals identify similar or identical elements.

FIG. 1 shows a block diagram of a data sharing system operating in accordance with exemplary embodiments of the present invention;

FIG. 2 shows a flow diagram of a data access in accordance with exemplary embodiments of the present invention;

FIG. 3 shows additional detail of the flow diagram of FIG. 2;

FIG. 4 shows a flow diagram of a connection speed determination in accordance with exemplary embodiments of the present invention;

FIG. 5 shows a block diagram of the system hierarchy of the data sharing system of FIG. 1;

FIG. 6 shows a block diagram of the user menu hierarchy of the data sharing system of FIG. 1;

FIG. 7 shows a mobile device login screen in accordance with exemplary embodiments of the present invention;

FIG. 8 shows a mobile device data entry screen in accordance with exemplary embodiments of the present invention;

FIG. 9 shows a mobile device task clock in screen in accordance with exemplary embodiments of the present invention;

FIG. 10 shows a mobile device expense data entry screen in accordance with exemplary embodiments of the present invention;

FIG. 11 shows a mobile device user status screen in accordance with exemplary embodiments of the present invention;

FIG. 12 shows a computer task data entry screen in accordance with exemplary embodiments of the present invention;

FIG. 13 shows a computer expense data entry screen in accordance with exemplary embodiments of the present invention;

FIG. 14 shows a computer user status screen in accordance with exemplary embodiments of the present invention;

FIG. 15 shows a computer work time report screen in accordance with exemplary embodiments of the present invention;

FIG. 16 shows a computer login screen in accordance with exemplary embodiments of the present invention; and

FIG. 17 shows additional detail of the block diagram of FIG. 1.

### DETAILED DESCRIPTION

In accordance with embodiments of the present invention, tracking, reporting and sharing of user data is provided in real-time. For example, through centralized data storage and management, embodiments of the present invention might allow individual users, such as employees, to track and report their work time, expenses, schedules, or project status in real-time. Embodiments of the present invention might alternatively be used to allow administrators, such as managers or supervisors, to identify employee time status, employee expenses or project status in real-time.

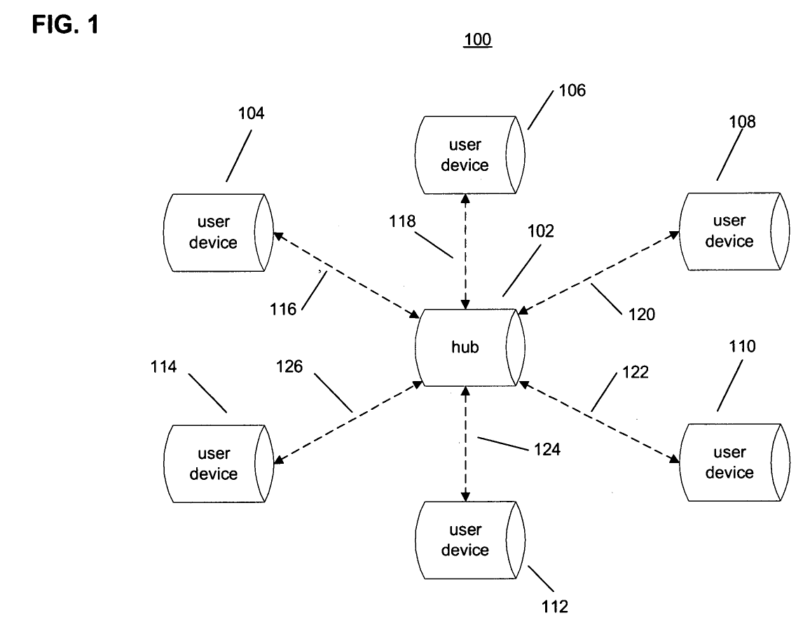

FIG. 1 shows a block diagram of data sharing system 100 operating in accordance with an exemplary embodiment of the present invention. As shown, data sharing system 100 includes hub 102 and a plurality of user devices 104-114. Each of the plurality of user devices might establish a bi-directional communication link with hub 102, as indicated by dashed lines 116-126. Communication links 116-126 might be wired or wireless communication links. A user device might be, for example, a computer having a connection to a network, such as the internet. Alternatively, a user device might be, for example, a mobile device, such as a wireless application protocol (WAP) enabled mobile device. WAP is a subset of HyperText Markup Language (HTML) that allows cell phones and other mobile devices to access internet data in relatively small chunks compared to regular HTML.

Data sharing system 100 tracks and reports user work time, expenses, or project status in real-time. As used herein, the term “tracking information” is employed to refer to user work time, expenses, schedules, or project status, but is not limited to this information, and includes similar information that supervisors or managers might desire to track, such as service costs, computer usage, phone usage, etc. Embodiments of the present invention do not require export of timesheet information from a user device since individual data points for tracking information are collected as they occur and recorded at, for example, hub 102 through the bi-directional communication links. Employing centralized data storage and management versus local data storage and management thus allows for data sharing of tracking information in real-time.

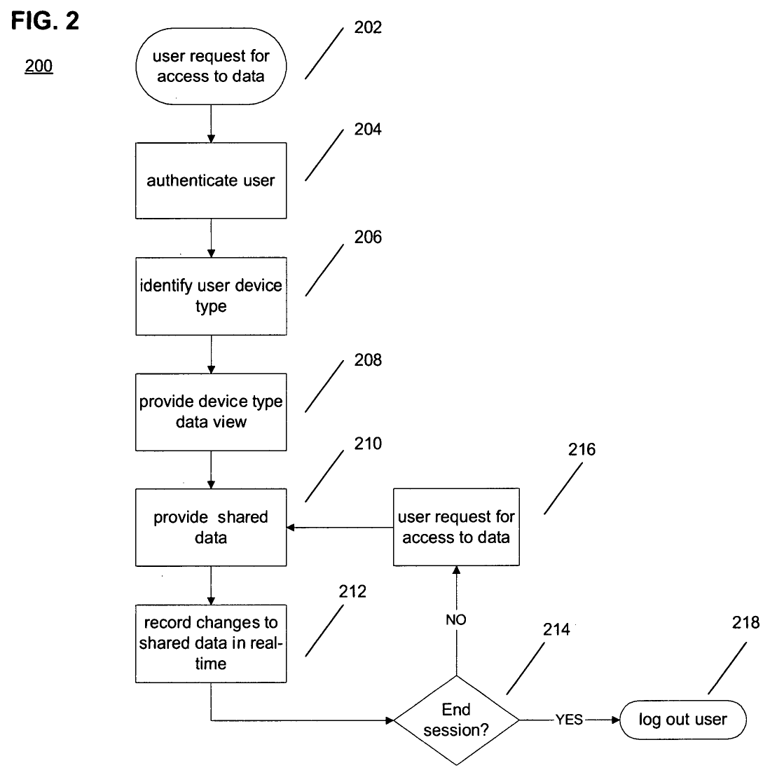

FIG. 2 shows a flow diagram of user data access request 200. As shown in reference to FIGS. 1 and 2, at step 202, a user might log into hub 102 via user device 104. User device 104 establishes a bi-directional communication link with hub 102, shown in FIG. 1 as dashed line 116. At step 204, the user is desirably identified by hub 102 as an authenticated user of data sharing system 100. The device type of user device 104 is determined at step 206. For example, the device type of user device 104 might be auto-detected by hub 102, or the user might manually select the device type, for example, by selecting whether user device 104 is a computer or a mobile device through a user interface at the user device. Based on the device type of the user device, embodiments of the present invention provide a specialized view of the shared data to the user.

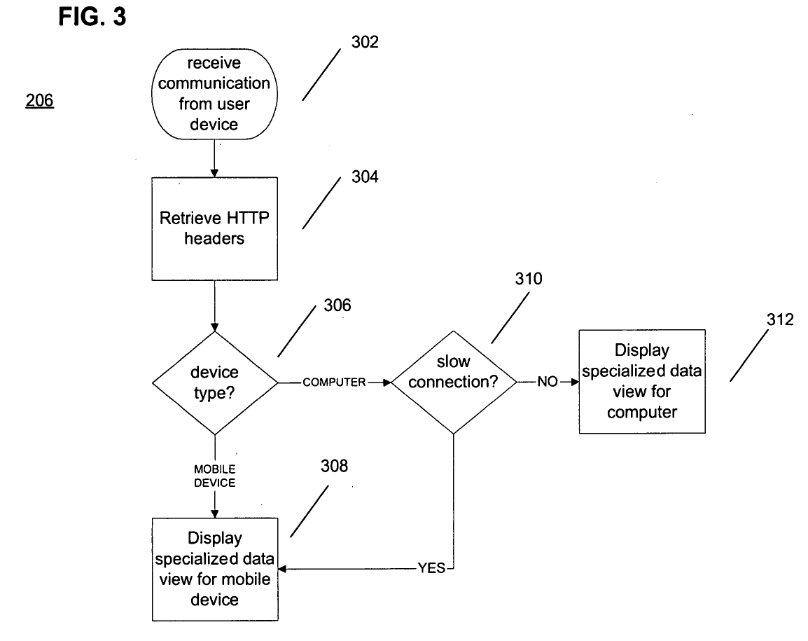

FIG. 3 shows a greater detail of step 206 of FIG. 2 when the user device type is automatically detected. Typically, a user device includes an internet browser application and an operating platform running on the user device. Automatic detection of the device type might detect the internet browser and operating platform running on a user device. In the initial communication between a webpage server, such as hub 102, and the internet browser application, the internet browser generally provides headers with information about itself and its capabilities to the server. As defined in the Hypertext Transfer Protocol specification (HTTP 1.1), there are 46 possible headers. At step 302, hub 102 receives a communication, such as a data access request, from user device 104. As described below, this communication includes HTTP header information, which is retrieved by hub 102 at step 304.

For example, the “from” header (or some other source of information) might provide an email address of the user making the request. Similarly, the “get” header might allow for a unique web address having an embedded username and password such as, for example, “http://www.mylinkx.com/login?login=<username>&password=<password>”. For mobile devices, a user might not be able to login or logout frequently. Thus, embodiments of the present invention provide for auto-login by employing the “from” header or the “get” header. For mobile devices, a user might choose to embed a username and password in the “from” header or the “get” header, which avoids repeated login verifications.

Other header information includes a user-agent header and content-type headers. The user-agent header identifies the program that's making the request, for example, in the form “program-name/xxx,” where “xxx” is an alphanumeric version identification of the program. Content-type headers might describe, for example, supported languages and character sets, supported scripting types, or supported content.

At step 306, based upon the received user-agent and other content-type headers, hub 102 might determine what internet browser and what operating platform are running on the user device. For example, hub 102 might determine that the user device is a computer running the operating platform Microsoft Windows® and the internet browser Mozilla Firefox®. Hub 102 might also determine additional information, such as the version of the operating platform or internet browser, or settings and capabilities of the internet browser. Based on the determined internet browser and operating platform, hub 102 might provide a specialized data view for the determined user device type. If user device 104 is a mobile device, hub 102 provides a specialized data view for mobile devices at step 308. If user device 104 is a computer, hub 102 might optionally, as shown in FIG. 3, check the communication link connection speed at step 310, or might provide a specialized data view for a computer at step 312.

For example, when user device 104 is a computer, at step 312, hub 102 might provide a relatively greater amount of data than when user device 104 is a mobile device. Embodiments of the present invention employ local data caching and asynchronous JavaScript (AJAX) requests. In general, using AJAX, the user device might retrieve data from hub 102 in the background without interfering with the display and behavior of an existing page. Traditionally, webpages consist of: 1) Headers, 2) CSS Stylesheets, 3) JavaScript files, 4) Application Headers, 5) Actual Data, 6) Application Footers, and 7) Images (such as icons, backgrounds, etc.). Thus, the actual data is only a small part of the overall page data.

For example, on a typical webpage, the actual data might be as little as 1-2% of the whole page data. Most pages for a website typically have substantially the same data for 2) CSS Stylesheets, 3) JavaScript files and 7) Images. By employing local caching, a user device need only download the data for these items once. Consequently, the user device need not re-request this information, and data downloaded by the user device per access request can be reduced by as much as 40-50%. Using local caching and AJAX, instead of requesting the whole web page, the user device might only request the actual page data from hub 102. For example, the actual page data might be tracking information as described previously. Thus, the amount of data transmitted is greatly reduced because only the actual page data is provided. Further, the rate of display of information on the user device is increased because the user device internet browser only processes the actual page data and not the other information. By utilizing caching and AJAX requests, embodiments of the present invention limit the amount of data transferred between hub 102 and the user device.

Embodiments of the present invention provide for a specialized data view for mobile devices that requires sending less than 1 kilobyte (kB) of data to the mobile device per each data access. Thus, hub 102 provides a specialized data view for mobile devices at step 308. For example, when a user device is a mobile device, hub 102 might provide WAP-enabled data that allows the mobile device to access the data in smaller chunks. By sending WAP-enabled data, platform-specific and browser-specific compatibility issues of mobile devices might be minimized. For example, less sophisticated mobile devices support WAP, such as many cell phones. Thus, embodiments of the present invention provide seamless integration of any WAP-enabled mobile device, without the need for custom software applications for each type of mobile device, and without the need for relatively more sophisticated user devices such as smartphones or personal digital assistants (PDAs). Embodiments of the present invention might provide for specialized data views for smartphones or PDAs that employ an intermediate amount of data between the specialized data view for a computer and the specialized data view for a mobile device generally. Further, a specialized data view for a smartphone or PDA might further be specialized to the specific type of smartphone or PDA detected.

Information, such as connection speed, about the communication link between hub 102 and a user device might also be determined, shown in FIG. 3 as the inquiry of step 310. For example, when a user device is a computer, more data might be sent than if the user device is a mobile device. However, when the computer has a slow internet or network connection, it might be desirable to provide the computer with a specialized data view that sends less data.

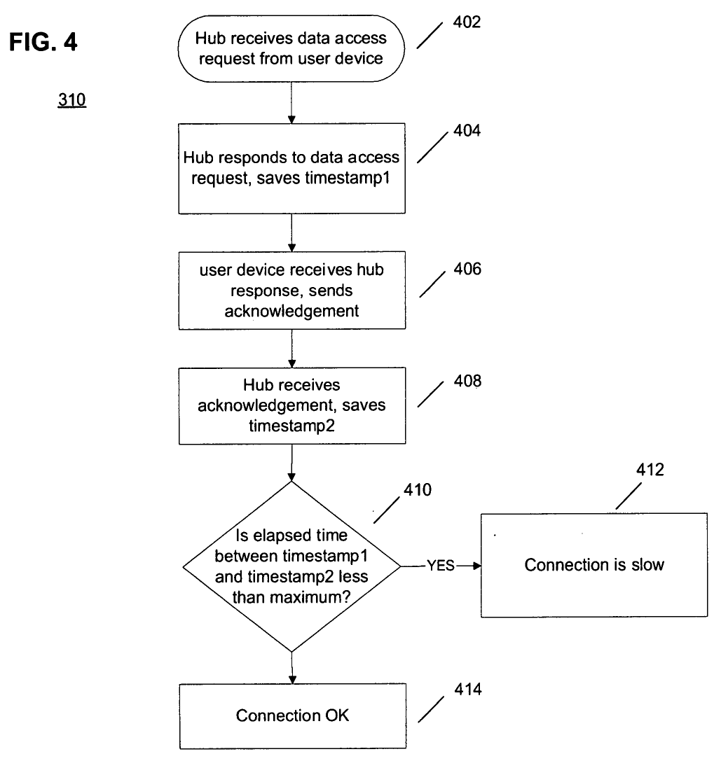

Embodiments of the present invention might detect the communication link connection speed by step 310, as shown in FIG. 4. Referring to FIG. 4, user device 104 requests access to data stored on hub 102 at step 402. Hub 102 responds to the data request at step 404. At step 404, hub 102 also saves a timestamp of the time when the response was sent. The response sent by hub 102 includes a request that an acknowledgement signal be sent back to hub 102 by user device 104. At step 406, user device 104 receives the response from hub 102 and sends the requested acknowledgement signal. Hub 102 receives the acknowledgement signal at step 408. At step 410, hub 102 determines the elapsed time between the timestamp saved at step 404 and the time acknowledgement signal was received at step 408. If the elapsed time exceeds a predetermined maximum time threshold, hub 102 will determine that the communication link between user device 104 and hub 102 is slow. In an exemplary embodiment, the predetermined maximum time threshold is 8 seconds, which would correspond to a connection speed of less than 128 kbps. At step 412, hub 102 determines that the communication link is slow, and hub 102 updates its settings such that user device 104 will receive a less-data intensive specialized view for slow connections at step 308 of FIG. 3. Alternatively, hub 102 could send a prompt asking the user if they want to change to the less-data intensive specialized view for slow connections. If the elapsed time does not exceed a predetermined maximum time threshold, hub 102 determines that the communication link between user device 104 and hub 102 is acceptable, and at step 414, hub 102 updates its settings such that user device 104 receives the specialized view for the determined user device type such as, for example, a computer, as described with respect to step 312 of FIG. 3. Thus, embodiments of the present invention provide a specialized view for computers having slow internet or network connections. In an exemplary embodiment, the less-data intensive specialized view for slow connections is the same as the specialized view for mobile devices.

Embodiments of the present invention provide that each authenticated user of data sharing system 100 might be assigned various permissions to access or alter shared data stored on hub 102. These user permissions might be retrieved from a stored user database, or might be assigned on-the-fly at the user authentication step 204 of FIG. 2. For example, a general user might be assigned a permission level to view and edit his or her own shared data, but might not have permission to view or edit shared data of any other users. An unknown user might not be given permission to access or alter shared data. An administrator might be assigned a permission level to view all users' shared data. Further, an administrator might be assigned a permission level to run reports summarizing shared data. Embodiments of the present invention provide that data might be transmitted in an XML (Extensible Markup Language) format to allow the user to customize his or her data view based on input criteria. For example, an administrator might be able to view shared data in reports by user, by project, by tasks within a project, by expense type, by customer, etc. Further comparisons, between users, customers, projects, etc. might also be reported.

Embodiments of the present invention provide for the creation of collaborative storage drives. A collaborative storage drive is a storage space in data sharing system 100 that might be shared by any users having sufficient permissions to access the space. For example, a collaborative drive might created on a storage volume in hub 102, or the collaborative drive might be created on a storage volume on a remote server that is accessible to users to data sharing system 100. A collaborative storage drive might be created “on-the-fly” based upon user input without disruptive action by hub 102. For example, to create a logical partition of a drive located on hub 102, disruptive action such as a restart might be required. Further, once a logical partition is created, its size is fixed.

Embodiments of the present invention provide collaborative storage drives that function similarly to a logical partition, but facilitate varying size. For example, a collaborative drive might be a secure folder created on a storage volume. The secure folder is assigned a predetermined amount of storage space. Embodiments of the present invention check the available storage space on each collaborative storage drive at periodic intervals. If the storage space available on a collaborative storage drive becomes less than a predetermined threshold, embodiments of the present invention might automatically increase the storage space available to that collaborative drive. Alternatively, an administrator of the collaborative drive might be prompted to increase the storage space available to the collaborative drive.

Collaborative storage drives might be mapped to the computers of those users with sufficient permissions to access the drives. Moreover, permissions to existing collaborative user drives might be changed “on-the-fly” based upon user input without action by hub 102. The contents of the collaborative storage drive might be viewable from an internet browser, and thus a collaborative drive can be viewed using any operating platform. For example, a collaborative drive might be viewable using standards such as WebDAV, SVN and HTML, thus making a collaborative storage drive viewable by both mobile devices and computers running any operating system. Embodiments of the present invention provide separate Access IDs for logging in to a collaborative drive. By using Access IDs, an additional level of security is provided for collaborative storage drives in addition to the individual usernames and passwords required to log in to data sharing system 100. Further, use of Access IDs allows for a collaborative storage drive to be shared by multiple people without the need to share their individual usernames or passwords that allow access to the rest of data sharing system 100. Thus, a collaborative storage drive can be shared by multiple users without exchanging their personal usernames or passwords.

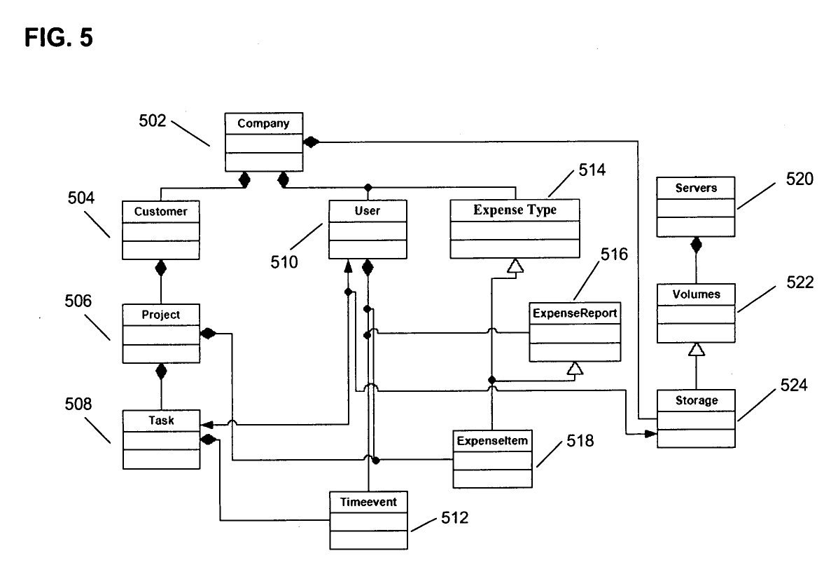

FIG. 5 shows a block diagram of the system hierarchy of data sharing system 100 shown in FIG. 1. A plurality of business organizations might use data sharing system 100, one of which is shown in FIG. 5 as company 502. Each company might have one or more clients or customers, shown as customer data 504. Customer data 504 includes a list representing all of the clients or customers of company 502. A company might further be employed to perform multiple projects for each client or customer. Thus, each customer represented in customer data 504 might have one or more corresponding projects, shown as project data 506. Further, each individual project might include one or more corresponding tasks, shown as task data 508.

Company 502 might also have one or more employees having stored information on data sharing system 100, shown as user data 510. User data 510 includes a list representing all the employees of company 502 who are authorized to use data sharing system 100. Each employee listed in user data 510 might have various permissions (not shown in FIG. 5) for accessing or altering data stored by data sharing system 100. As indicated in FIG. 5, each employee listed in user data 510 might have one or more corresponding time events, shown as time event data 512. Further, each employee listed in user data 510 might have one or more corresponding tasks, shown as task data 508. For example, a time event might include the clock in time, the clock out time and the elapsed time that an employee was working on a given task. As indicated, each task in task data 508 might have one or more corresponding time events, such as multiple employees working on the same task (each user has his or her own corresponding entry in time event data 512), or the same employee working on the task multiple times (one employee has multiple entries in time event data 512). As will be described, embodiments of the present invention provide for employees to create direct links on their homepage to their tasks (“myTasks”).

Company 502 might also have multiple expense categories for tracking types of business expenses and purchases, shown as expense type data 514. Expense type data 514 includes a list representing each expense type defined by company 502. For example, company 502 might have expense categories for equipment purchases, supplies, travel, etc. As shown in FIG. 5, each project listed in project data 506 might have one or more corresponding expenses, shown as expense item data 518. As indicated, each expense in expense item data 518 might include references to the user who performed the task, to the category of the expense, and to the project (and, thus, the customer) for which the expense was incurred. Each employee listed in user data 510 might generate expense reports for submission to company 502 for reimbursement or payment. Thus, one or more of the expenses in expense item data 518 might be compiled into one or more expense reports, shown as expense report data 516.

As described above, embodiments of the present invention provide for creation of collaborative storage drives. As shown in FIG. 5, company 502 might have one or more collaborative storage drives, shown as storage 524. Storage 524 might be accessible by one or more employees listed in user data 510. As shown, storage 524 might be a portion of a volume 522, such as a hard disk drive or a solid state disk, which is part of a server, for example, hub 120 or a remote server. Server 520 might include one or more volumes.

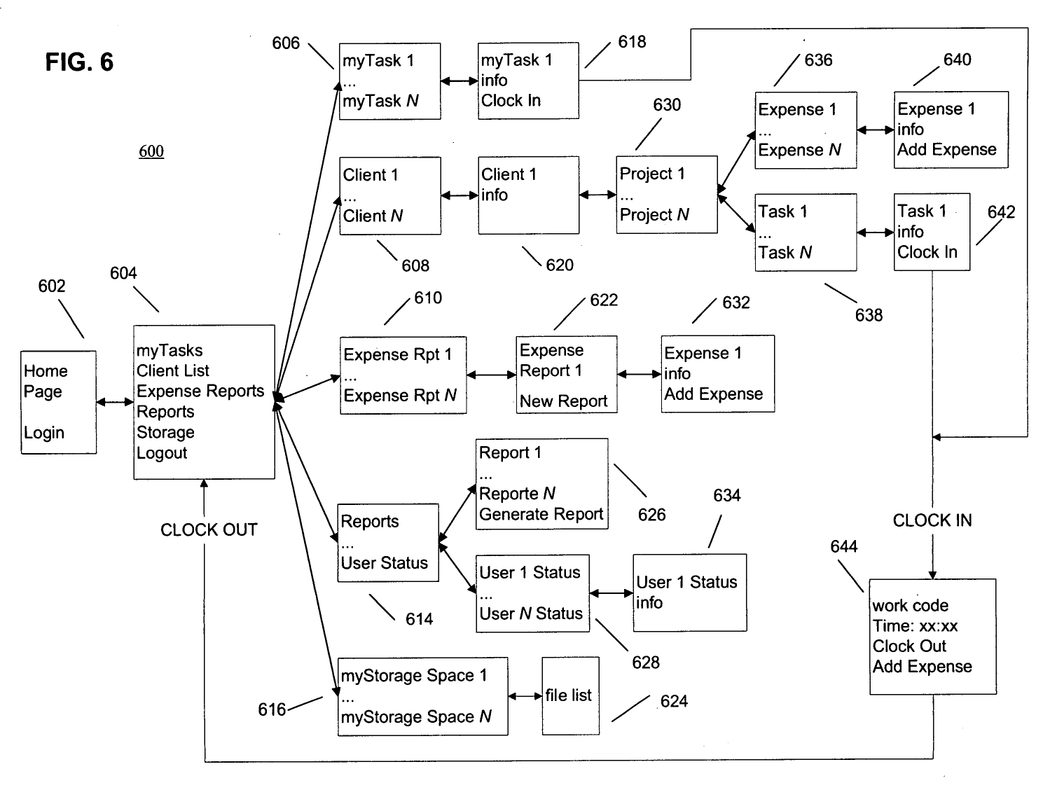

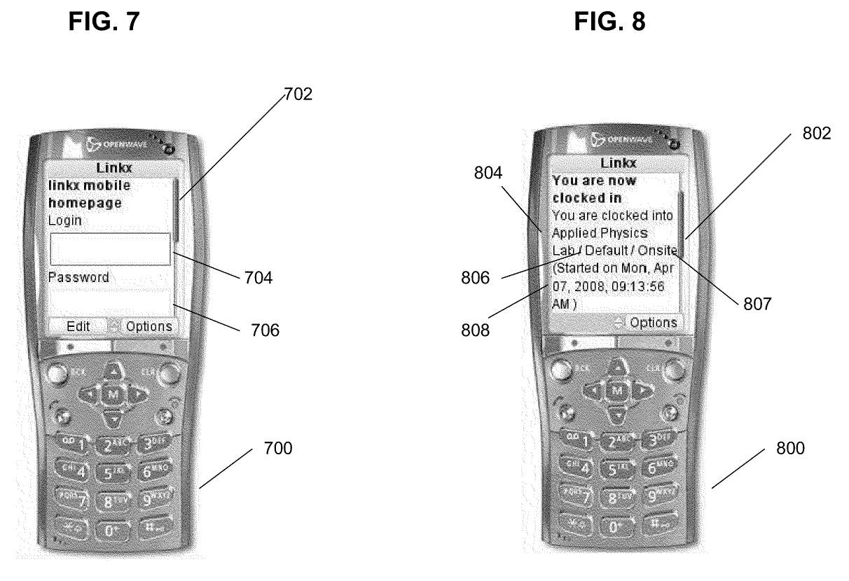

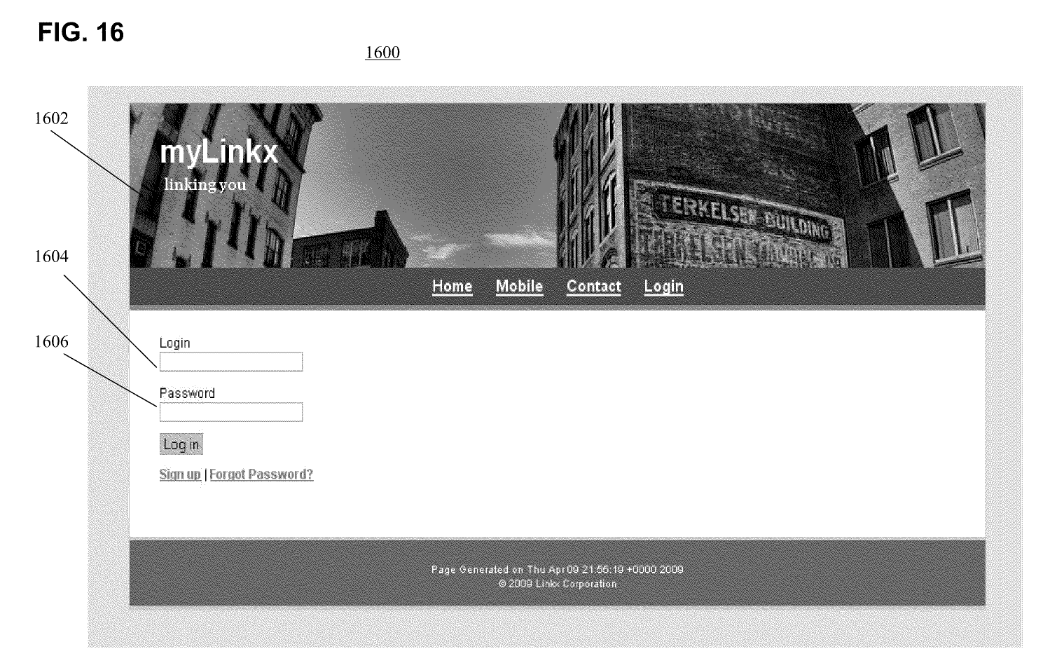

FIG. 6 shows user menu hierarchy 600 of data sharing system 100 shown in FIG. 1. In operation, a user of data sharing system 100 logs in at login screen 602. For example, login screen 602 might require a user to enter their username and password. Alternatively, as described previously, login screen 602 might be bypassed, for example for mobile devices, if the username and password of a user are embedded in the “from” header or the “get” header sent by the user device. As described above, the amount of data provided to the user device and displayed on each menu screen depends on the user device type. FIG. 7 shows exemplary login screen 702 for mobile device 700. As shown, mobile device login screen 702 includes username entry field 704 and password entry field 706. FIG. 16 shows exemplary login screen 1600 for a computer. As shown, computer login screen includes username entry field 1604 and password entry field 1606, and also might include additional data or graphics, shown as 1602.

If the entered username and password are correct for an authenticated user of data sharing system 100, main menu screen 604 is displayed. Main menu screen 604 allows the user to access the data stored on data sharing system 100 that the logged in user has permission to access. For example, main menu screen 604 might allow a user to access the user's tasks stored in task data 508, the corporate customer list data 504, or collaborative storage 524. Main menu screen 604 might further allow a user to view expenses stored in expense item data 518, or to view an expense report stored in expense report data 516. Main menu screen 604 might further provide a direct link to a user's accessed tasks, called “myTasks”.

As shown in FIG. 6, when the user selects the “myTasks” option on main menu screen 604, data sharing system 100 provides myTask menu screen 606 to the user device. MyTask menu screen 606 displays a list of N tasks, where N is a positive integer. In exemplary embodiments of the present invention, up to N tasks might be selected by the user, or data sharing system 100 might provide a predetermined number (N) of the most recently accessed tasks by the user, or data sharing system 100 might provide a predetermined number (N) of the most frequently accessed tasks by the user. Furthermore, exemplary embodiments of the present invention might automatically include tasks in a user's myTasks list when the user accepts a task assignment from another user, or when a user creates or schedules a task. From myTask menu screen 606, the user might go back to main menu screen 604, or might select a specific task and move to task information screen 618. Task information screen 618 provides the user with information on the selected task, and allows the user to “clock in” to the task. “Clocking in” to a task allows a user to record work time on the selected task.

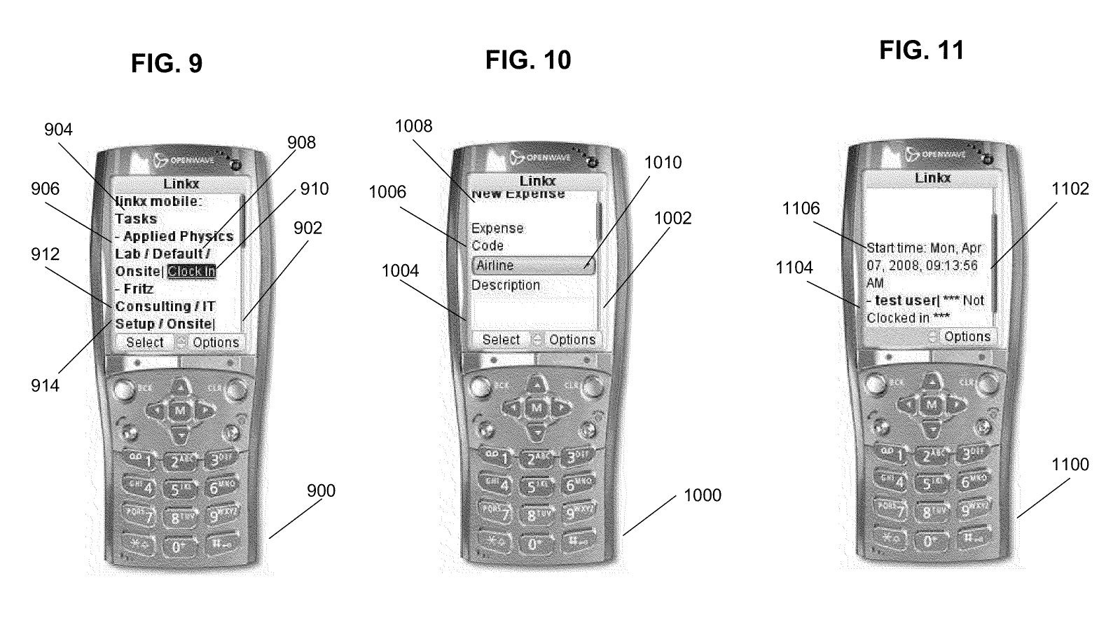

FIG. 9 shows exemplary myTasks screen 902 for mobile device 900. As shown, mobile device myTasks screen 902 includes title field 904, a first client 906 having a first task 908 and a link 910 to clock in to task 908, and a second client 912 having a first task 914. The present invention is not limited to displaying only two client tasks on myTasks screen 902, and other display layouts are possible depending on the number of tasks selected to appear on myTasks screen 902.

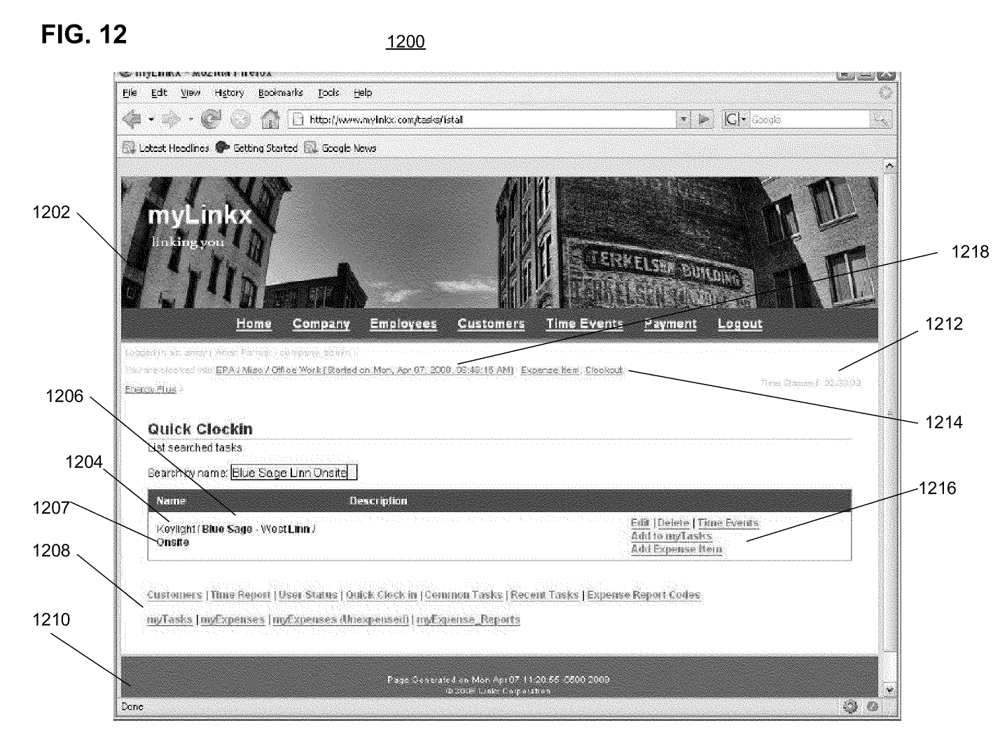

As shown in FIG. 6, when the user selects to clock in to a task, data sharing system 100 provides task clocked in screen 644 to the user device. Task clocked in screen 644 might provide the user with information on the currently clocked in task, for example the task code or the elapsed work time. Task clocked in screen 644 might also provide the user with a clock out link or other information. FIG. 8 shows exemplary task clocked in screen 802 for mobile device 800. As shown, mobile device task clocked in screen 802 includes customer name 804 (“Applied Physics Lab”), project name 806 (“Default”), task name 807 (“Onsite”), and clock in time 808 (“Mon, Apr. 7, 2008, 9:13 AM”). FIG. 12 shows exemplary task clocked in screen 1200 for a computer. As shown, computer task clocked in screen includes customer name 1204 (“Keylight”), project name 1206 (“Blue Sage West Linn”), task name 1207 (“Onsite”), and clock in time 1218 (“Mon, Apr. 7, 2008, 9:49 AM”). Computer task clocked in screen 1200 also includes elapsed time counter 1212, menu links 1216, and clock out link 1214. Menu links 1216 might, for example, allow the user to edit information about the task or add a new task. Time event data might include, for example, the clock in time, the clock out time, the user, the task, and the elapsed time. Computer task clocked in screen 1200 also might include additional data or graphics, shown as 1202, 1208, and 1210. When the user selects clock out link 1214, the timer on hub 102 is stopped and time event data is saved for the task. Further, when the user selects clock out link 1214, data sharing system 100 provides main menu screen 604 to the user device. Further, embodiments of the present invention provide that a user might clock in from one type of user device and then perform subsequent operations from another type of user device. For example, a user might clock in from a computer when they are leaving their work site to travel to a client's job location. Further, the user might perform subsequent operations using a mobile device while at the client's job location.

As shown in FIG. 6, when the user selects the “Client List” option on main menu screen 604, data sharing system 100 provides client menu screen 608 to the user device. Client menu screen 608 displays a list of the customers or clients of company 502, for example up to N clients, where N is a positive integer. The user might select one client to view additional client information at client screen 620. Client screen 620 might display information about the client, such as name, address or contact information. Client screen 620 might also show a list of projects for the selected client, shown in FIG. 6 as separate screen 630. From project list screen 630, the user can choose to view expenses related to the selected project at expense screen 636. From expense screen 636, the user can choose to view additional information about the selected expense or add a new expense at expense detail screen 640. From project list screen 630, the user can also choose to view tasks related to the selected project at task screen 638. From expense screen 638, the user can choose to view additional information about the selected task or clock in to a selected task at task detail screen 642. FIG. 10 shows exemplary add new expense screen 1002 for mobile device 1000. As shown, mobile device add new expense screen 1002 includes title 1008, expense description field 1004, expense code selection menu 1006 and selected expense code 1010.

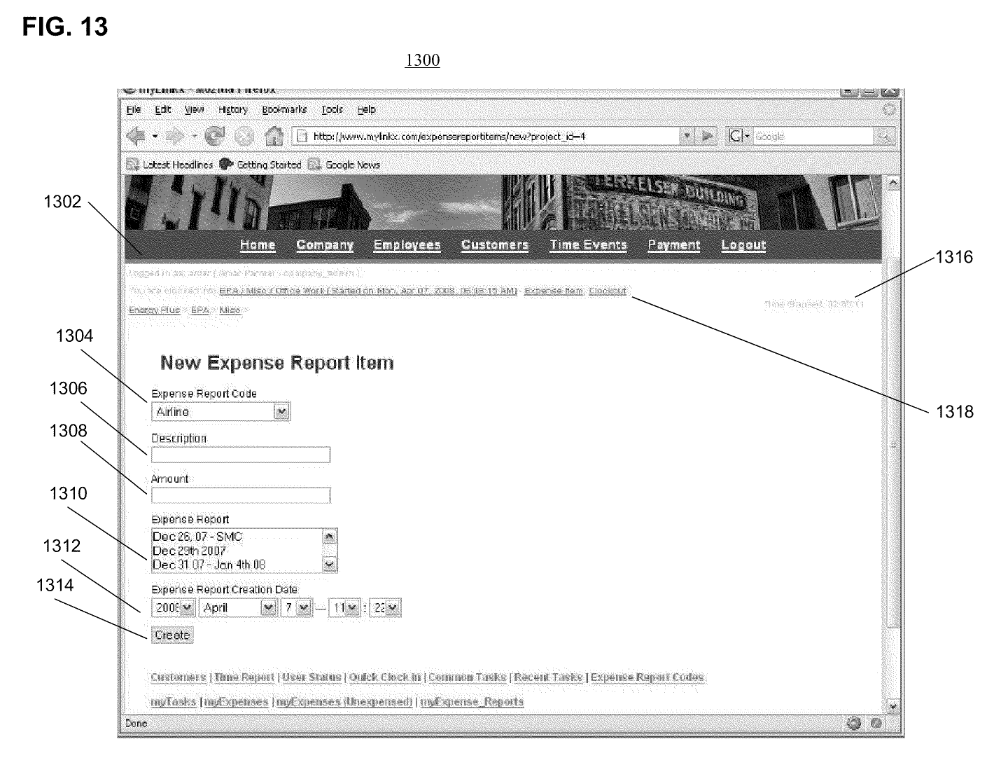

As shown in FIG. 6, when the user selects the “Expense Reports” option on main menu screen 604, data sharing system 100 provides expense report menu screen 610 to the user device. Expense report menu screen 610 displays a list of expense reports of the user, for example up to N current or previous expense reports, where N is a positive integer. The user might select one expense report to view additional information about an existing expense report, add an expense to an existing expense report, or generate a new expense report at screen 622. The user might view additional information about existing expenses at screen 632. FIG. 13 shows exemplary screen 1300 for a computer to add an expense item to an expense report. As shown, computer screen 1300 includes expense code selection menu 1304, expense description field 1306, expense amount field 1308, date field 1312 and create button 1314. Screen 1300 also includes list 1310, containing names of existing open expense reports that might be selected by the user to include the current expense item. Computer generate new expense report screen 1300 also might include additional data or graphics, shown as 1302.

As shown in FIG. 6, when the user selects the “Reports” option on main menu screen 604, data sharing system 100 provides report menu screen 614 to the user device. Report menu screen 614 displays a list of report types, for example monitoring user status. Other reports might be generated, for example, summary reports providing shared data organized by user, project, tasks, expense type or customer. Further, summary reports providing shared data as comparisons between users, comparisons between customers, comparisons between projects, and comparisons between expense types might also be generated. Aggregate reports for all users might also be possible, such as all expenses for a client, all employees' time for a client, comparisons between time spent on each project for a client, or comparisons between tasks spread across projects or clients. The user might select one report to view additional information about an existing report or generate a new report at screen 626. The user might select to view user status at screen 628. User status screen 628 might provide the status of all users of data sharing system 100.

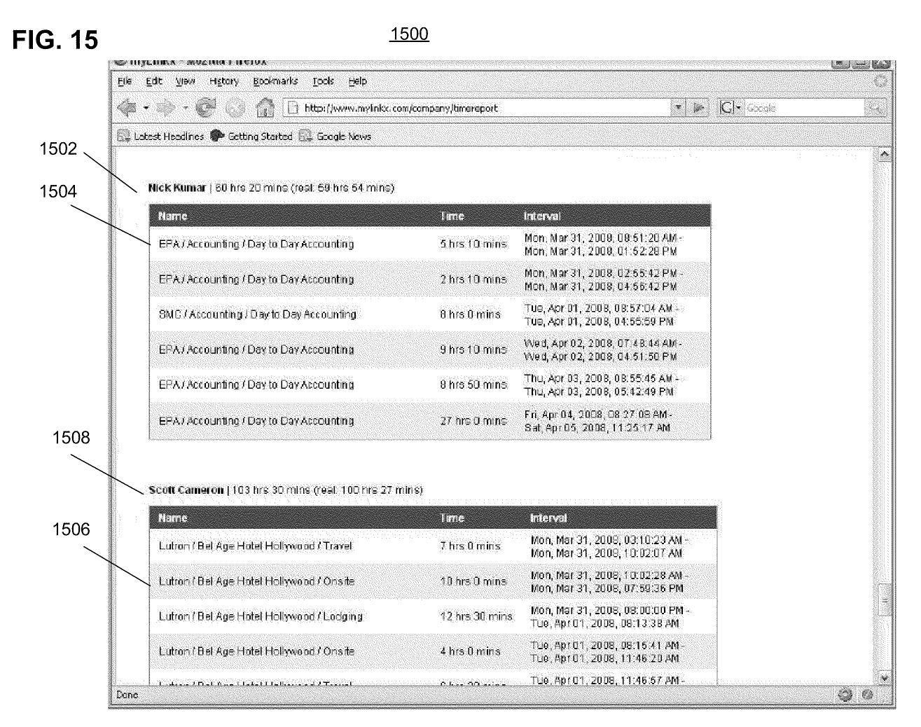

For example, FIG. 15 shows exemplary work time report screen 1500 for a computer. In exemplary embodiments of the present invention, it might be desirable for a supervisor or manager to be able to see the work time entries of subordinates. As shown, exemplary work time report screen 1500 includes reports for users 1502 and 1508. These reports include individual time entries, shown collectively as 1504 and 1506. Individual time entries within 1504 and 1506 might include the client name, the task name, the elapsed work time and the start and stop times.

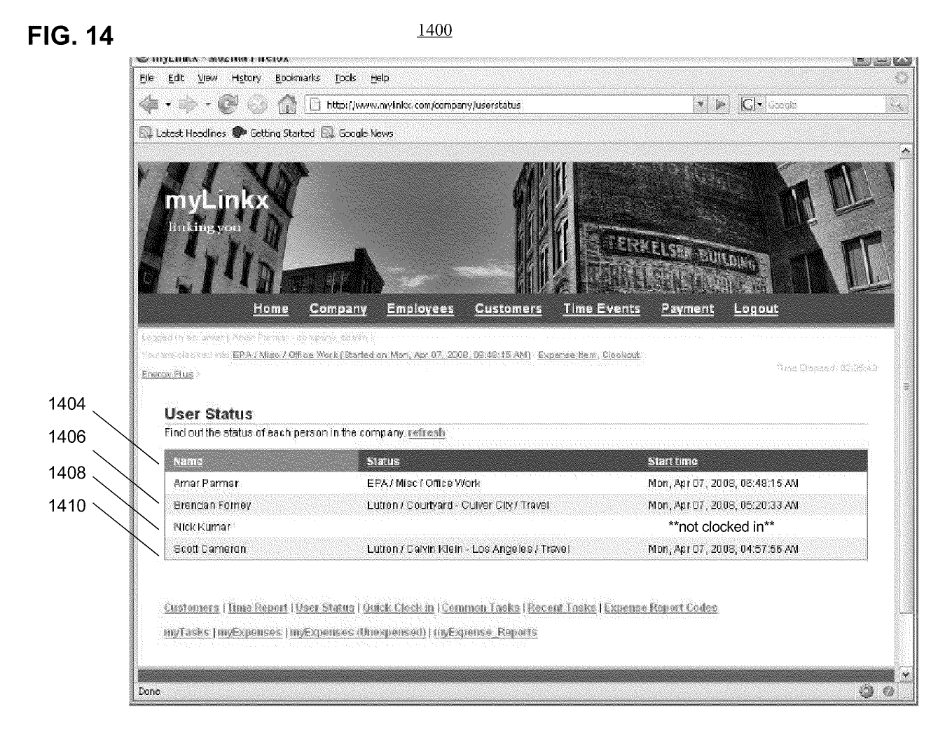

The user might select to view user status at screen 628. User status screen 628 might provide the status of all users of data sharing system 100. FIG. 14 shows exemplary real-time user status screen 1400 for a computer. As shown, real-time user status screen 1400 includes status entries for users 1404, 1406, 1408 and 1410. Each status entry might include a status indicator whether each user is clocked in to work or not which is updated in real-time as a user clocks in or out. Further, each status entry might include the name of the client, project or task that each user is currently clocked in to work on. Analogously, FIG. 11 shows exemplary real-time user status screen 1102 for mobile device 1100. As shown, real-time user status screen 1102 includes status entries for user 1104 and a field indicating the time of the status report in field 1106. Each status entry might include a status indicator whether each user is clocked in to work or not which is updated in real-time as a user clocks in or out. Further, each status entry might include the name of the client, project or task that each user is currently clocked in to work on.

As shown in FIG. 6, when the user selects the “Storage” option on main menu screen 604, data sharing system 100 provides storage menu screen 616 to the user device. Storage screen 616 displays a list of collaborative storage drives for which the user has permission to access data. The user might select one of the collaborative storage drives to view the contents of the drive at explorer screen 624.

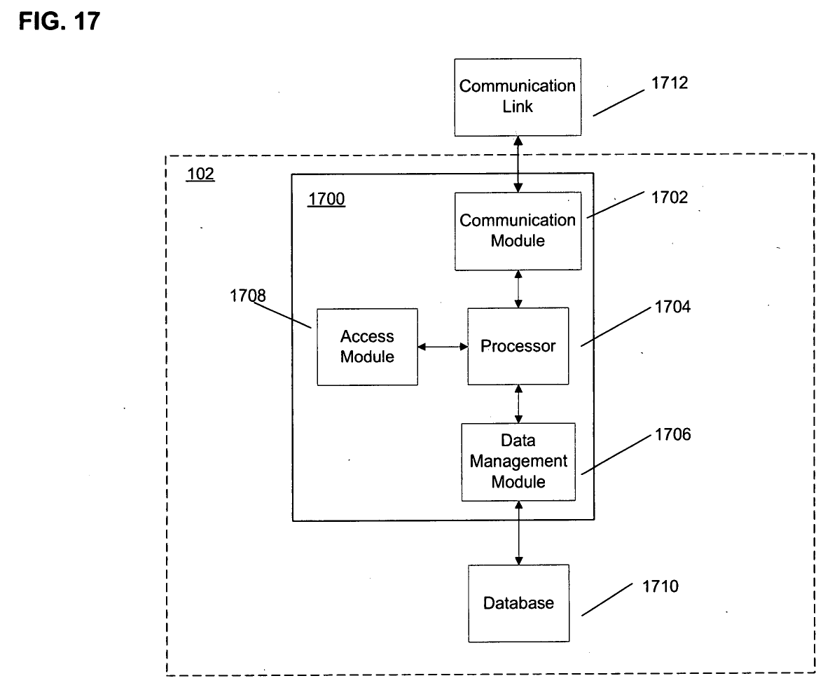

FIG. 17 shows additional detail of hub 102 of FIG. 1. As shown in FIG. 17, hub 102 might include controller 1700 for controlling access to database 1710. Controller 1700 might include communication module 1702 for sending and receiving data from communication link 1712 and data management module 1706 for accessing data stored on database 1710 in real-time. Controller 1700 might further include access module 1708 for determining one or more permissions for users requesting access to database 1710, for example, read access, write access, administrator access, etc. Controller 1700 might further include processor 1704 for processing of data received from communication module 1702 and data management module 1706. Processor 1704 might also determine a device type associated with each user request for access to database 1710, and provide a specialized data view to communication module 1702 based on the determined device type. For example, if a user request originated from a mobile device, processor 1704 might format data from database 1710 such that processor 1704 provides a mobile device specialized data view to communication module 1702. Communication module 1702 provides the specialized data view to communication link 1712 to be provided to the user device.

In accordance with the above described embodiments of the present invention, provided is the following example of data sharing system 100 in operation. A user might log into hub 102 of data sharing system 100 from user device 104 via communication link 116. When user device 104 is a computer, a computer specialized data view is provided to display a main menu screen. Based on one or more determined permissions for the user, the main menu screen is formatted to provide the user access to data stored on the database. For example, if the user has administrator permissions, the user might be able to view all data stored in the database. From the main menu screen, a user might select a task and clock in for work on the task. Each task is associated with a customer/client and a project code. Once a user clocks in, work time is tracked by and stored on hub 102. Thus, users having sufficient permissions can view, in real-time, the work status of other users. Further, users having sufficient permissions can view, in real-time, which tasks are active. Other real-time reports and status monitoring might be provided, for example, expense tracking or approval.

While clocked in to a task, if the user is temporarily interrupted, the user might pause the clock if the interruption is not work related. Alternatively, the user might enter a manual time mode to track time for another task. Embodiments of the present invention further provide for automatic pausing of the clock for the first task when a user clocks in to another task. When the user is finished working on a task, the user might clock out of the task. Hub 102 saves the clock in time, the clock out time and the elapsed time in the database. Embodiments of the present invention might provide users with reminders to clock-in or clock-out at predetermined intervals.

If the user forgets to clock in or out of a task, or the tracked time is not correct, the user can request an adjustment and specify an amount of time to be adjusted. For example, if a user works for 30 minutes on a task before clocking in, the user could request an adjustment of 30 minutes. Embodiments of the present invention provide for flagging time entries where an adjustment was entered. Further, in all cases, all raw entered data and, thus, a data history, is saved in addition to the adjusted data. Due to the centralized storage and tracking of shared data by hub 102, user data is accessible in real-time to other users with sufficient permissions. Thus, embodiments of the present invention provide a way for supervisors to more quickly and accurately track their employees' work times, for example, by allowing a supervisor to see whether an employee has clocked in yet and whether that employee is currently working on a project. Further, a supervisor might be able to determine an employee is frequently requesting adjustments to his or her time records, and the supervisor might review the raw data entered by the employee to determine whether an issue exists.

Some embodiments of the present invention provide that users with sufficient permissions might set a time tracking policy of data sharing system 100. For example, a user with administrator permissions might be able to set a default time increment for billing purposes. Alternatively, a user with administrator permissions might be able to set a threshold for rounding tracked work time to the next billing increment. For example, a default time billing increment might be set to 6 minutes. Further, a rounding threshold might be set to 2 minutes, such that tracked work time up to 2 minutes might be rounded down to zero for billing purposes, but tracked work time exceeding 2 minutes might be rounded up to the next 6 minute billing increment.

Thus, as described above, embodiments of the present invention provide real-time tracking of shared data. The shared data might include user work time, expenses, user scheduling, projects, project status and milestones, client service costs, computer usage and phone usage and real-time status of individuals at remote locations. Further, embodiments of the present invention facilitate monitoring of, and data sharing with, employees at remote locations. Thus, embodiments of the present invention provide advantages for organizations where employees are not present in one physical location because prior time tracking solutions might have required an employee's physical presence and did not provide for real-time access to the time-tracking data. For example, embodiments of the present invention do not store information locally on each user's computer until it is finalized and submitted or exported to a manager or supervisor; rather, embodiments of the present invention provide for real-time sharing and monitoring of user data. Additionally, embodiments of the present invention provide advantages by providing for data access by most types of mobile devices without the need for custom software applications.

It will be further understood that various changes in the details, materials, and arrangements of the parts which have been described and illustrated in order to explain the nature of this invention may be made by those skilled in the art without departing from the scope of the invention as expressed in the following claims.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

While the exemplary embodiments of the present invention have been described with respect to processes of processing blocks in a software program that might be employed in, for example, a digital signal processor, micro-controller, or general purpose computer, the present invention is not so limited. As would be apparent to one skilled in the art, various functions of circuit elements might also be implemented as circuit elements, including possible implementation as a single integrated circuit, a multi-chip module, a single card, or a multi-card circuit pack.

The present invention can be embodied in the form of methods and apparatuses for practicing those methods. The present invention can also be embodied in the form of program code embodied in tangible media, such as magnetic recording media, optical recording media, solid state memory, floppy diskettes, CD-ROMs, hard drives, or any other machine-readable storage medium, wherein, when the program code is loaded into and executed by a machine, such as a computer, the machine becomes an apparatus for practicing the invention. The present invention can also be embodied in the form of program code, for example, whether stored in a storage medium, loaded into and/or executed by a machine, or transmitted over some transmission medium or carrier, such as over electrical wiring or cabling, through fiber optics, or via electromagnetic radiation, wherein, when the program code is loaded into and executed by a machine, such as a computer, the machine becomes an apparatus for practicing the invention. When implemented on a general-purpose processor, the program code segments combine with the processor to provide a unique device that operates analogously to specific logic circuits. The present invention can also be embodied in the form of a bitstream or other sequence of signal values electrically or optically transmitted through a medium, stored magnetic-field variations in a magnetic recording medium, etc., generated using a method and/or an apparatus of the present invention.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the present invention.

As used herein in reference to an element and a standard, the term “compatible” means that the element communicates with other elements in a manner wholly or partially specified by the standard, and would be recognized by other elements as sufficiently capable of communicating with the other elements in the manner specified by the standard. The compatible element does not need to operate internally in a manner specified by the standard.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. Signals and corresponding nodes or ports may be referred to by the same name and are interchangeable for purposes here.

We claim:

1. A method of accessing stored data representing real-time tracking information shared among a plurality of users, the method comprising the steps of:
a) identifying a user request for access to stored data;
b) identifying a device type associated with the user request;
c) determining one or more permissions for the user request;
d) accessing, based on the one or more permissions determined, a portion of the stored data; and
e) providing the portion of stored data through one of a plurality of specialized data views to the device, based on the device type,
whereby the stored data representing real-time tracking information is seamlessly provided to a plurality of different device types and a status of each of the plurality of users is tracked in real-time.

2. The invention of claim 1, wherein the step of providing the one specialized data view comprises formatting the specialized data view based on the device type, wherein the device type is at least one of a computer and a mobile device.

3. The invention of claim 2, wherein the step of providing the one specialized data view formatted for a mobile device provides less than 1 kB of data per user access of stored data.

4. The invention of claim 1, wherein the step of identifying the device type further comprises: automatically detecting the device type as at least one of a computer or a mobile device.

5. The invention of claim 1, wherein the step of identifying the device type further comprises: manually selecting the device type by the user at the device as at least one of a computer or a mobile device.

6. The invention of claim 1, wherein, the step of determining one or more permissions further comprises determining permissions assigned to a user of the identified user request, wherein the permissions comprise the group of: read access, write access, and administrator report access.

7. The invention of claim 1, further comprising the step of:
storing data input by the user in response to the one of the plurality of specialized views provided to the user.

8. The invention of claim 1, wherein the stored data representing real-time tracking information comprises at least one of: work time, expenses, user scheduling, projects, project status, client service costs, computer usage and phone usage.

9. A machine-readable medium, having encoded thereon program code, wherein, when the program code is executed by a machine, the machine implements a method of tracking and sharing user activity representing real-time tracking information among a plurality of users, the method comprising the steps of:
a) identifying a user request for access to stored data;
b) identifying a device type associated with the user request;
c) determining one or more permissions for the user request;
d) accessing, based on the one or more permissions determined, a portion of the stored data; and
e) providing the portion of stored data through one of a plurality of specialized data views to the device, based on the device type,
whereby the stored data representing real-time tracking information is seamlessly provided to a plurality of different device types and a status of each of the plurality of users is tracked in real-time.

10. The invention of claim 9, wherein the user activity representing real-time tracking information comprises at least one of: work time, expenses, user scheduling, projects, project status, client service costs, computer usage and phone usage.

11. The invention of claim 9, wherein the step of providing the one specialized data view comprises formatting the specialized data view based on the device type, wherein the device type is at least one of a computer and a mobile device.

12. The invention of claim 11, wherein the step of providing the one specialized data view formatted for a mobile device provides less than 1 kB of data per user access of stored data.

13. The invention of claim 9, wherein the step of identifying the device type further comprises: automatically detecting the device type as at least one of a computer or a mobile device.

14. The invention of claim 9, wherein, the step of determining one or more permissions further comprises determining permissions assigned to a user of the identified user request, wherein the permissions comprise the group of: read access, write access, and administrator report access.

15. The invention of claim 9, further comprising the step of:
storing data input by the user in response to the one of the plurality of specialized views provided to the user.

16. The invention of claim 9, further comprising:
generating summary reports of shared data.

17. The invention of claim 16, wherein the summary reports provide shared data organized by one of: user, project, tasks within a project, expense type, and customer.

18. The invention of claim 16 wherein the summary reports provide shared data as one of: comparisons between users, comparisons between customers, comparisons between projects, and comparisons between expense types.

19. Apparatus for tracking and sharing, among a plurality of users, data representing real-time tracking information, comprising:
a) a database adapted to store the data representing real-time tracking information;
b) a controller adapted to control access to the database by user requests, wherein user requests originate from a plurality of user devices coupled to a communication link, the controller further comprising:
i) a communication module adapted to transmit to and receive data from the communication link;
ii) a processor adapted to determine a device type a user device corresponding to each user request;
iii) an access module adapted to determine one or more permissions for each user request; and
iv) a data management module adapted to provide real-time access to data stored in the database;
wherein, based on the one or more permissions determined by the access module, a portion of the stored data is accessed by the data management module, and, based on the device type determined by the processor, the portion of stored data is provided, as one of a plurality of specialized data views, to the communication link, by the communication module, for communication to the user device, whereby the data representing real-time tracking information is seamlessly provided to a plurality of different device types and a status of each of the plurality of users is tracked in real-time.

20. The invention of claim 19, wherein the user activity representing real-time tracking information comprises at least one of: work time, expenses, user scheduling, projects, project status, client service costs, computer usage and phone usage.
